(19) United States
(12) Patent Application Publication
(10) Pub. No.: US 2003/0140723 A1
(43) Pub. Date: Jul. 31, 2003

(54) Bearing sphere for a gear shift lever

(75) Inventor: Carsten Zimmermann, Dassel-Lauenberg (DE)

Correspondence Address: WILLIAM COLLARD, COLLARD & ROE, P.C., 1077 NORTHERN BOULEVARD, ROSLYN, NY, 11576, US

(73) Assignee: Teleflex Automotive Germany GmbH

(21) Appl. No.: 10/339,998

(22) Filed: Jan. 10, 2003

(30) Foreign Application Priority Data
Jan. 29, 2002 (DE) 102 03 547.4

(51) Int. Cl. B60K 20/00

(52) U.S. Cl. 74/473.34

(57) ABSTRACT

A bearing sphere for a gear shift lever is provided, preferably for a transmission for motor vehicles, in which the bearing sphere is disposed around the shift rod and the selection finger. The bearing sphere consists of two half-shells, which are releasably connected with the shift rod, the selection finger, and one another. Each half-shell has at least one depression for the shift rod, at least one claw element around the shift rod, an opening to hold an opposite claw element, at least one centering pin, and at least one hole for a centering pin, as well as an opening for the selection finger. The bearing sphere has the advantage that it no longer has to be produced on the gear shift lever using the injection-molding process, but rather can be affixed so as to be releasably connected with the shift rod, with little effort.

### BACKGROUND OF THE INVENTION

### CROSS REFERENCE TO RELATED APPLICATIONS

Applicant claims priority under 35 U.S.C. §119 of German Application No. 102 03 547.4 filed Jan. 29, 2002.

1. Field of the Invention

The present invention relates to a bearing sphere for a gear shift lever, preferably for a motor vehicle transmission, having the bearing sphere around the shift rod and the selection finger. The invention can be used anywhere where shift levers must be mounted in a bearing for their movement, using a bearing sphere.

2. The Prior Art

The use of bearing spheres in order to mount a shift rod and the selector finger in the shift housing of the transmission has been known for a long time.

Furthermore, it is known to conduct a part that is molded on, from the bearing sphere, in a direction along the shift rod, on which part there is a bead that serves as a position stop relative to the housing during shifting. Both the bearing sphere and the part that is molded on, which is located on it, are generally affixed to the shift rod and to the selection finger located on it as a non-releasable connection. The bearing sphere is affixed where the selector finger is arranged on the shift rod. Affixing takes place so that the sphere, and, if applicable, the part that is molded on, if they are made of rubber, are vulcanized on, and, if they are made of plastic, that they are applied using the injection-molding process. This is done so that the shift rod, with the selector finger located on it, are placed into an injection-molding mold, melted plastic granulate is applied to the surface of the metal parts using the injection-molding process, in such a manner as the injection-molding mold provides. After the plastic has cured, the injection-molding mold can be removed, and afterwards, the shift lever is available for installation in the transmission.

EP 0 990 821 A1 discloses a shift lever with a bearing sphere, in which the bearing sphere and the part that is molded on, which follows the sphere, are rigidly connected with the shift lever. It is apparent that the bearing sphere and the part that is molded on are produced by being injection-molded onto the shift lever. U.S. Pat. No. 5,357,823 also discloses the bearing sphere of a shift lever, which is rigidly connected with the shift lever and was produced by means of injection-molding. The bearing sphere has lateral openings through which an axle projects. This bearing sphere, also, was produced according to one of the aforementioned methods.

In any case, according to the state of the art, the bearing sphere must be produced by means of one of the proposed methods; this requires a very specific technology and is not very advantageous in terms of cost.

Furthermore, the bearing sphere as well as the part that is molded on, in some cases, cannot be removed from the shift rod without great effort, so that in case of wear, replacing it is only possible with great effort.

### SUMMARY OF THE INVENTION

It is therefore the task of the invention to create a bearing sphere that does not demonstrate the disadvantages of the state of the art, and is not applied to the shift rod by means of an injection-molding or vulcanization process, and can be removed from the shift rod again, if necessary, with little effort.

This task is accomplished by means of a bearing sphere for a gear shift lever in which the bearing sphere as two half-shells, which are releasably connected with the shift rod, the selection finger, and one another. Each half-shell has at least one depression for the shift rod, at least one claw element around the shift rod, one opening to hold an opposite claw element, at least one centering pin, and at least one hole for a centering pin. An opening for the selection finger is also provided. Other advantageous features are discussed below.

According to the invention, a bearing sphere consists of two half-shells, which are releasably connected with the shift rod, the selection lever, and one another. In this connection, each half-shell has at least one depression for the shift rod, and at least one claw element into which the shift rod can be clipped.

It is advantageous if each half-shell has at least two claw elements next to one another, into which the shift rod can be clipped. In this connection, the distance between the claw elements should be exactly large enough so that the claw elements of the opposite half-shell lie next to the corresponding claw elements of the other half-shell. In each half-shell, there is a cavity for the opposite claw element, so that when the two half-shells are clipped onto the shift rod, a completely closed sphere is formed.

If a shift finger is present, one of the two hemispheres has an opening for the shift finger. However, it is also possible to arrange the openings for the shift finger so that each of the two hemispheres has a part of the opening, if the shift finger is supposed to be arranged in such a way that it runs along between the two shift spheres, which might not be advantageous for the strength of the shift sphere, under some circumstances.

Furthermore, each half-shell has at least one centering pin, which projects into an opening of the opposite half-shell, and increases the stability of the connection to prevent displacement of the half-shells relative to one another.

It is advantageous if each half-shell has two centering pins and two openings for the centering pins.

Furthermore, it is advantageous if the half-shells have the shape of a hemisphere.

If movement of the shift lever in the immediate vicinity of the bearing sphere needs to be restricted, it is advantageous to lengthen the half-shells by means of a so-called part that is molded on, along the shift rod. The function of the position stop relative to the housing can be achieved by means of a bead on the part that is molded on.

For this purpose, it is advantageous to apply a groove on the part that is molded on, on both half-shells, into which an element for holding the half-shells together in this region is arranged. It is advantageous if this element is a rubber piece that takes over the function of the bead, at the same time.

It is advantageous to produce the two half-shells of plastic or aluminum.

Furthermore, it is advantageous if the part that is molded on has at least one centering element for a stopping element.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a side view of two half-shells that lie opposite one another, in accordance with an embodiment of the invention.

FIG. 2 shows a cross-section along the shift rod of two half-shells around a shift rod with a selection finger.

FIG. 3 shows half-shells around a shift rod and the selection finger, in a cross-section crosswise to the shift rod.

FIG. 4 shows a half-shell in a side view, crosswise to the shift rod.

FIG. 5 shows a half-shell in a side view, crosswise to the selection finger.

### DETAILED DESCRIPTION OF PREFERRED EMBODIMENTS

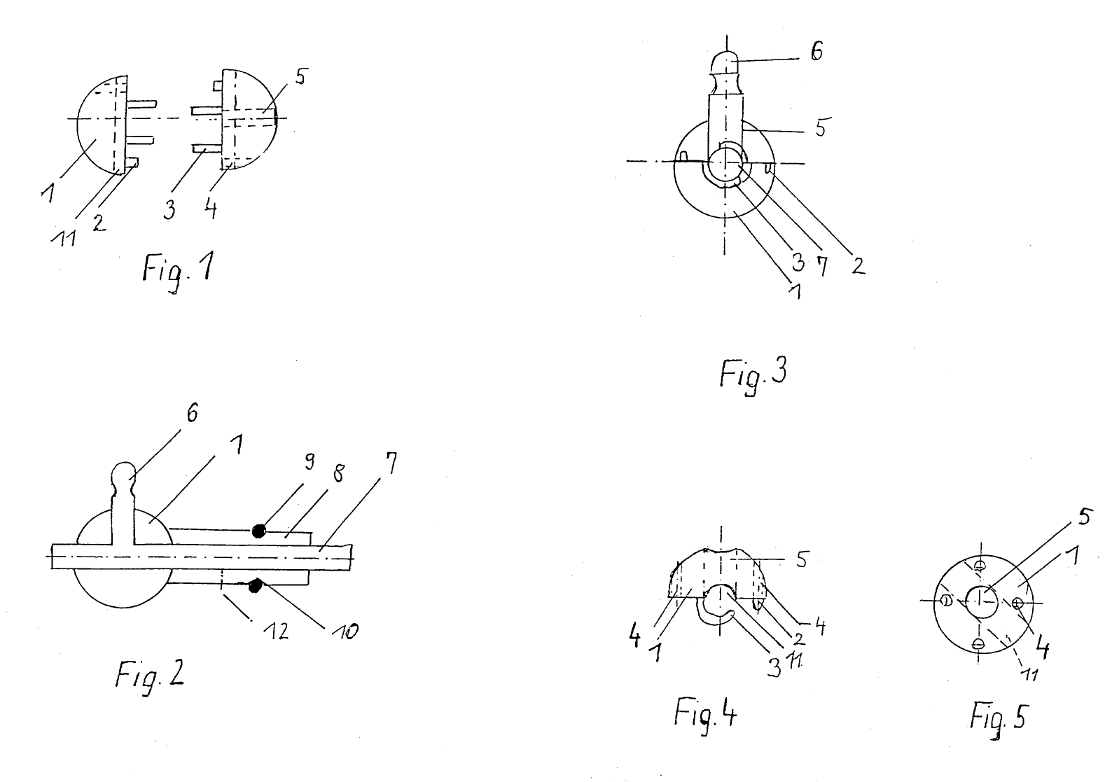

FIG. 1 shows a bearing sphere for a shift rod and a selection finger including two half-shells 1 that lie opposite one another, on which four claw elements 3 are arranged, which lie next to one another so that they can easily pass by one another. Preferably, each half-shell is made from plastic or aluminum and has the shape of a hemisphere. Between the two half-shells 1, there is a depression 11, into which the shift rod 7 can be clipped. An opening or bore 5 for the selection finger 6 shown in FIG. 2 is arranged in one of the two half-shells 1. Centering pins 2 are arranged between the two half-shells 1, which glide into the opposite holes 4 in the half-shells when the half-shells are joined together, to increase the stability of the half-shells with regard to twisting. Preferably, each bearing shell 1 has two cylindrical pins 2 diagonally opposite one another and two holes 4 for the cylindrical pins of the opposite half-shell diagonally opposite to each other.

FIG. 2 shows two half-shells 1 around a shift rod 7, whereby selection finger 6 projects through one half-shell 1. A part or extension 8 that is molded on half-shell 1 is arranged along shift rod 7. Molded part 8 has a groove 10, in which a rubber part or connector is located, which holds the two parts that are molded on together, and, also forms a bead 9 that forms the position stop in the housing of the transmission. A centering element 12 is arranged on the part 8 that is molded on, to form a stop.

FIG. 3 shows two half-shells 1 in cross-section, crosswise to shift rod 7, in which claw elements 3 around shift rod 7 and centering pins 2 are visible. Opening 5 for selection finger 6 is made in the top half-shell 1.

FIG. 4 shows the top half-shell 1 without the bottom half-shell 1, the selection finger, and the shift rod. Claw element 3, which is provided in half-shell 1 to hold shift rod 7, together with depression 11, is made to be elastic, so that shift rod 7 can be clipped into the opening or clearance between claw element 3 and half-shell 1. Preferably, each claw element has the shape of a ring segment with the distance between the end of the ring segment and the half-shell, being large enough to allow the shift rod 7 to be clipped between them.

In the present case, two claw elements 3 lie behind one another.

FIG. 5 shows the top half-shell 1 with bore 5 for selection finger 6 and holes 4 for two centering pins 2 that lie opposite one another, in each instance, in half-shell 1. Depression 11 runs diagonally through this half-shell 1.

With this solution, it is possible to produce a bearing sphere, if necessary with a part molded on, around a gear shift lever, without a non-releasable connection around the gear shift lever coming about. The bearing shift sphere can therefore be assembled quickly and with little effort, and, if necessary, can be disassembled again with little effort.

While only a few embodiments of the present invention have been shown and described, it is to be understood that many changes and modifications may be made thereunto without departing from the spirit and scope of the invention as defined in the appended claims.

What is claimed is:

1. A bearing sphere for a gear shift lever including a shift rod and a selection finger, which comprises first and second half-shells releasably connected with one another and at least one selection finger opening for receipt of the selection finger formed in one of said half-shells or formed by both half-shells when connected to each other, each of said half-shells having:
(a) at least one depression for receipt of the shift rod;
(b) at least one claw element adapted to be disposed around the shift rod;
(c) an opening for receipt of an opposite claw element of the other half-shell;
(d) at least one centering pin; and
(e) at least one hole for receipt of a centering pin of the other half-shell.

2. The bearing sphere according to claim 1 wherein each half-shell has two cylindrical centering pins diagonally across from one another in said half-shell and two holes for receipt of two cylindrical centering pins of the other half-shell.

3. The bearing sphere according to claim 1 wherein each half-shell has two claw elements, each of said claw elements comprising an elastic ring segment and separated from a corresponding claw element on the other half-shell by a distance large enough to allow the shift rod to be clipped between said claw elements and the corresponding claw elements on the other half-shell.

4. The bearing sphere according to claim 1 wherein the opening for the selection finger is arranged in one of said half-shells.

5. The bearing sphere according to claim 1 wherein the opening for the selection finger is formed by both half-shells.

6. The bearing sphere according to claim 1 wherein each half-shell forms a hemisphere.

7. The bearing sphere according to claim 1 wherein each half-shell forms a hemisphere and comprises a molded extension molded on the half-shell and arranged along the shift rod.

8. The bearing sphere according to claim 7 wherein each molded extension includes a position stop for the shift rod.

9. The bearing sphere according to claim 8 wherein said position stop comprises a bead on each molded extension.

10. The bearing sphere according to claim 8 wherein said position stop comprises a rubber connector connecting said half-shells and each molded extension has a groove for receipt of said rubber connector.

11. The bearing sphere according to claim 7 wherein each molded extension has at least one centering element to form a stop element.

12. The bearing sphere according to claim 1 wherein the half-shells are plastic or aluminum.
